(19) United States
(12) Patent Application Publication
(10) Pub. No.: US 2005/0237602 A1
(43) Pub. Date: Oct. 27, 2005

(54) Light amplification element, light amplification apparatus and light amplification system

(75) Inventor: Masahiro Yanagisawa, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/114,036

(22) Filed: Apr. 26, 2005

(30) Foreign Application Priority Data
Apr. 26, 2004 (JP) 2004-129598

(51) Int. Cl. H01S 3/00

(52) U.S. Cl. 359/340

(57) ABSTRACT

A small, low power consumption light amplifier using stimulated Raman scattering is provided. A Raman active section 18 and a rough surface metal part 21 are provided on one end face of an optical fiber 11, excitation light is irradiated onto the rough surface metal part 21, surface plasmon is generated and signal light 15 is amplified into amplified signal light 16 using stimulated Raman scattering in the interface between the rough surface metal part 21 irradiated with the signal light 15 which has propagated through the core 12 and the Raman active section 18.

### BACKGROUND OF THE INVENTION

1. Field of the Invention

The present invention relates to a light amplification element, light amplification apparatus and light amplification system, and more particularly, to a small, low power consumption light amplification element, light amplifier and light amplification system.

2. Description of the Related Art

A light amplification apparatus using stimulated Raman scattering is disclosed, for example, in Japanese Patent Laid-Open No. 60-241288 or “Fiber Raman Amplifier” (Optronics, No. 8, Optronics Co., Ltd., 1999, p. 111-117). As shown in FIG. 39 and FIG. 40, according to a conventional Raman light amplification apparatus, signal light 97 and excitation light 98 are mixed in a quartz optical fiber by a multiplexer 102 and input to an optical fiber 103. When the excitation light 98 propagates through the fiber, stimulated Raman scattering occurs and the signal light 97 is amplified. The amplified signal light 97 is separated from the excitation light through a demultiplexer 104 or filter.

On the other hand, as a technology related to concentrated light amplification without using any optical fiber, it is reported in “Local Plasmon Photonic Transistor”, Appl. Phys Lett, Vo 1.78, No. 17, pp 2417-2419 (2001) that when excitation light having a wavelength of 635 nm was irradiated onto a dielectric layer containing silver particles, intensity of light having a wavelength of 405 nm increased and that when input power of long-wavelength light is increased, output intensity of short-wavelength light and output intensity of long-wavelength light are increased.

A Raman amplification apparatus generally amplifies signal light using stimulated Raman scattering. A light amplification apparatus using stimulated Raman scattering using an optical fiber disclosed in Japanese Patent Laid-Open No. 60-241288 and “Fiber Raman Amplifier” (Optronics, No. 8, Optronics Co., Ltd., 1999, p. 111-117) has low Raman amplification efficiency, and therefore requires an optical fiber as long as several kilometers, which increases the size of the amplification apparatus. Furthermore, producing stimulated Raman scattering requires intensity of excitation light to be equal to or greater than a threshold. For this reason, there is a problem that obtaining a sufficient amplification gain requires a high output excitation light source and also requires greater power consumption. Furthermore, since excitation light and signal light are mixed in an optical fiber, a multiplexer/demultiplexer and demultiplexer or filter for multiplexing/demultiplexing excitation light into/from signal light are required, which results in problems of producing an insertion loss and decreasing intensity of the signal light.

On the other hand, as a light amplification technology without using any optical fiber, a technology disclosed in “Local Plasmon Photonic Transistor”, Appl. Phys Lett, Vol. 78, No. 17, pp 2417-2419 (2001) is neither phototransistor nor light amplification element, but a light variable attenuator and is totally different from Raman amplification. That is, as shown in Document 1, signal light having a longer wavelength than the wavelength of the input excitation light is amplified through Raman amplification and the output intensity of excitation light decreases as the signal light increases, and therefore Document 1 does not express any Raman amplification phenomenon.

One of objects of the present invention is to provide a small, low power consumption light amplification element and light amplification apparatus through high efficiency Raman amplification. Another object of the present invention is to provide a low-loss light amplification element and light amplification apparatus using a structure in which excitation light is not mixed with signal light in the same waveguide.

### SUMMARY OF THE INVENTION

The inventor has made various investigations into light amplification through stimulated Raman scattering and consequently discovered that exciting surface plasmon in an element would increase stimulated Raman scattering through a strong electric field of this surface plasmon and can increase amplification of signal light considerably. The light amplification element of the present invention is based on a light amplification phenomenon through this surface plasmon.

A first light amplification element according to the present invention is characterized by comprising a structure with a metal part that has a negative dielectric constant and a Raman active section arranged adjacent to each other. When an interface between the metal part and Raman active section has a rough surface, it is possible to efficiently excite plasmon when the metal part is irradiated with excitation light.

The convexo-concave structure which forms the rough surface of the interface may also have periodicity. The rough surface preferably includes a shape and array having a fractal structure. Furthermore, even if the metal part has a rough surface, it is possible to efficiently excite plasmon when the metal part is irradiated with excitation light.

When the rough surface of the metal part has at least one micro shape having a diameter of 100 nm or below and when there are two or more micro shapes, the closest distance of the respective micro shape and array preferably falls within a range of 0.5 nm to 50 nm.

The rough surface of the metal part preferably includes periodically formed concentric grooves or a periodically formed fractal structure.

A second light amplification element of the present invention is a light amplification element comprising a metal part having a negative dielectric constant and a Raman active section, characterized in that signal light is amplified by irradiating the metal part with excitation light. Surface plasmon generated when the metal part is irradiated with excitation light increases the amplification of incident light through stimulated Raman scattering in the Raman active section.

By entering at least part of the light component of the excitation light at the position of incidence upon the metal part at an angle at which surface plasmon is generated, surface plasmon is generated in the metal part.

The metal part and Raman active section are preferably arranged adjacent to each other, and excitation light and signal light are preferably reflected on the interface between the metal part and Raman active section.

It is more preferable that the metal part have a rough surface and the convexo-concave structure forming the rough surface be arranged with periodicity in the traveling direction of excitation light or signal light because it is possible to efficiently excite plasmon and further enhance the stimulated Raman scattering in the Raman active section.

A first light amplification apparatus of the present invention comprises a first or second light amplification element and a light guide provided with at least one light leakage region, characterized in that at least one of the leakage regions is provided with the light amplification element.

The light leakage region provided with the light amplification element may be provided on an end face or a side face of the light guide. As the light guide, both an optical fiber and flat light guide can be used.

The interface between the light leakage region and Raman active section is preferably provided with a rough surface.

A second light amplification apparatus of the present invention is characterized by comprising a first or second light amplification element and refraction means. By irradiating excitation light onto the metal part through refraction means at a certain angle of incidence of plasmon absorption, it is possible to efficiently excite plasmon and further enhance stimulated Raman scattering in the Raman active section.

The concentrated Raman light amplifier by the medium of surface plasmon of the present invention improves amplification efficiency and can thereby provide a smaller light amplifier with lower power consumption than a distributed Raman light amplifier using a conventional optical fiber. Furthermore, adopting a structure avoiding a mixture of signal light and excitation light can provide a low-loss light amplifier.

### BRIEF DESCRIPTION OF THE DRAWING

FIG. 1 is a cross-sectional view of a first embodiment of a light amplifier of the present invention;

FIG. 2 is a plan view of a rough surface machined end face of the first embodiment of the light amplifier of the present invention;

FIG. 3 is a plan view of a rough surface machined end face of the first embodiment of the light amplifier of the present invention;

FIG. 4 is a plan view of a rough surface machined end face of the first embodiment of the light amplifier of the present invention;

FIG. 5 is a plan view of a rough surface machined end face of the first embodiment of the light amplifier of the present invention;

FIG. 6 is a plan view of a rough surface machined end face of the first embodiment of the light amplifier of the present invention;

FIG. 7 is a cross-sectional view of a rough surface machined end face of the first embodiment of the light amplifier of the present invention;

FIG. 8 is a plan view of a rough surface machined end face of the first embodiment of the light amplifier of the present invention;

FIG. 9 is a plan view of a rough surface machined end face of the first embodiment of the light amplifier of the present invention;

FIG. 10 is a plan view of a rough surface machined end face of the first embodiment of the light amplifier of the present invention;

FIG. 11 is a cross-sectional view of a second embodiment of a light amplifier of the present invention;

FIG. 12 is a cross-sectional view of a third embodiment of a light amplifier of the present invention;

FIG. 13 is a cross-sectional view of a rough surface metal part of the third embodiment of the light amplifier of the present invention;

FIG. 14 is a cross-sectional view of a fourth embodiment of a light amplifier of the present invention;

FIG. 15 is a cross-sectional view of a rough surface metal part of the fourth embodiment of the light amplifier of the present invention;

FIG. 16 is a cross-sectional view of a fifth embodiment of a light amplifier of the present invention;

FIG. 17 is a cross-sectional view of a sixth embodiment of a light amplifier of the present invention;

FIG. 18 is a cross-sectional view of a seventh embodiment of a light amplifier of the present invention;

FIG. 19 is a cross-sectional view of a rough surface metal part of the seventh embodiment of the light amplifier of the present invention;

FIG. 20 is a cross-sectional view of an eighth embodiment of a light amplifier of the present invention;

FIG. 21 is a cross-sectional view of a ninth embodiment of a light amplifier of the present invention;

FIG. 22 is a cross-sectional view of a tenth embodiment of a light amplifier of the present invention;

FIG. 23 is a cross-sectional view of an eleventh embodiment of a light amplifier of the present invention;

FIG. 24 is a cross-sectional view of a twelfth embodiment of a light amplifier of the present invention;

FIG. 25 is a cross-sectional view of a thirteenth embodiment of a light amplifier of the present invention;

FIG. 26 is a cross-sectional view of a fourteenth embodiment of a light amplifier of the present invention;

FIG. 27 is a cross-sectional view of a fifteenth embodiment of a light amplifier of the present invention;

FIG. 28 is a cross-sectional view of a sixteenth embodiment of a light amplifier of the present invention;

FIG. 29 is a cross-sectional view of a seventeenth embodiment of a light amplifier of the present invention;

FIG. 30 is a plan view of a periodic rough surface metal film of a light amplifier of the present invention;

FIG. 31 is a cross-sectional view of a periodic rough metal part of the light amplifier of the present invention;

FIG. 32 is a cross-sectional view of a periodic rough metal part of the light amplifier of the present invention;

FIG. 33 is a cross-sectional view of a periodic rough metal part of the light amplifier of the present invention;

FIG. 34 is a cross-sectional view of manufacturing steps of the light amplifier of the present invention;

FIG. 35 is a cross-sectional view of manufacturing steps of the light amplifier of the present invention;

FIG. 36 is a cross-sectional view of manufacturing steps of the light amplifier of the present invention;

FIG. 37 is a cross-sectional view of manufacturing steps of a prism-like light amplifier of the present invention;

FIG. 38 is a cross-sectional view of manufacturing steps of a flat waveguide type light amplifier of the present invention;

FIG. 39 is a cross-sectional view of an embodiment of a conventional optical fiber type Raman amplifier; and

FIG. 40 illustrates an embodiment of a conventional optical fiber type Raman amplifier.

### DETAILED DESCRIPTION OF THE INVENTION AND PREFERRED EMBODIMENTS

(Operation)

Surface plasmon is a charge density wave of free electrons in a metal induced by an electrical field of light and propagates over a metal surface. A metal having a negative dielectric constant such as gold, silver, copper, aluminum, chromium, or more specifically a metal material having a dielectric constant whose real part is negative and having an absolute value of the real part which is greater than that of the imaginary part is characterized by promoting excitation of surface plasmon.

An element (hereinafter referred to as “light amplification element”) is formed with a structure comprising a metal part consisting predominantly of a metal having a negative dielectric constant and a Raman active section made of a material having Raman activity arranged adjacent to each other. Here, “metal part and Raman active section arranged adjacent to each other” does not mean a state in which there is no interposition of other film or air but also includes a state in which the Raman active section and metal part are separate from each other by a short distance with slight interposition of a degenerated film and air layer, etc., of the material making up the natural oxide film, Raman active section or metal part. Even in the case of separation by a short distance, if the electric field by surface plasmon which will be described later reaches the Raman active section and falls within a range within which the electric field can increase the amplification action of incident light in the Raman active section, this can be included in the technical scope within which “the metal part and Raman active section are arranged adjacent to each other.”

Excitation light is irradiated onto the metal part of this light amplification element and signal light to be amplified is introduced into the Raman active section. Excitation light may be irradiated from the interface with the Raman active section through the Raman active section or may also be irradiated from the side opposite to the interface. When at least the light component of part of excitation light is introduced into the metal part at an angle satisfying the conditions of surface plasmon, surface plasmon is generated in the metal part.

The electrical field created by surface plasmon acts on a Raman active material that contacts the interface with the metal and promotes stimulated Raman scattering. The intensity of the stimulated Raman scattering, that is, the intensity of the signal light increases in proportion to the cube of the field intensity. When surface plasmon occurs in even part of the metal part due to the excitation light, this plasmon causes a strong electric field to apply to the Raman active section and if the electric field exceeds a threshold, it is possible to obtain sufficiently strong light amplification.

When the metal part has a rough surface, a strong electric field occurs locally in the interface between the metal part and Raman active section, and therefore it is possible to further strengthen stimulated Raman scattering. When the metal surface has a periodic structure, surface plasmon resonance is likely to occur, the field intensity is further enhanced and it is possible to further strengthen stimulated Raman scattering. As the shape of the rough surface, various shapes such as random shape, periodic shape and fractal shape, etc., can be used. The fractal shape is a geometric shape having self-similarity. The shape of the rough surface is preferably made up of a relatively large structure which excites surface plasmon and produces further resonance and a micro structure which becomes a Raman scattering source. A convexo-concave structure having a periodic length equivalent to the excitation wavelength induces resonance of surface plasmon and obtains highly efficient Raman amplification action with concentrated field intensity.

The inventor experimentally confirmed that surface plasmon resonance is especially likely to occur when the periodic structure includes a fractal structure. Though reliable theoretical verification on the fractal structure has not been conducted yet, the inventor considers that the geometric shape having self-similarity caused surface plasmon excited over a wide range to efficiently concentrate on a micro area and produce highly efficient Raman amplification action. As a specific mode of the fractal shape, it is possible to use various shapes such as a dendritic shape, Mandelbrotset set, Julia set, Sierpinsky gasket, menger sponge as described in “Introduction to Fractal Science” (Nippon Jitsugyo Publishing Co., Ltd., 1990, frontispiece, p 18 to p 22).

The overall size of the fractal structure is greater than a wavelength, but the micro part of the self-similar shape preferably has the following micro size. The size of the rough surface section which becomes a Raman scattering source has a micro shape and array having a diameter of 100 nm or less of at least one micro shape and in the case of two or more micro shapes, the closest distance of the respective micro shape and array is 0.5 nm to 50 nm and preferably 1 nm to 10 nm.

Generation of Raman amplification due to interaction between surface plasmon and signal light is not limited to the case where the metal part has a rough surface. When the interface between the metal part and Raman active section is smooth, excitation light is introduced from the metal part side and signal light is introduced from the Raman active section side. By introducing the signal light into a smooth interface at an appropriate angle of incidence and also introducing the excitation light at an appropriate angle of incidence with respect to the metal part, it is possible to excite surface plasmon in the vicinity of the interface and amplify the signal light. Adopting the light amplification element of such a structure eliminates the necessity of an optical coupler to merge or separate the signal light and excitation light, and therefore it is possible to obtain light amplification with a low light insertion loss.

The Raman active material used for the Raman active section can be anything if it at least allows a Raman scattering spectrum to be observed, but a material having high polarizability is preferable. Furthermore, a material with high crystallinity can obtain strong Raman intensity and high light amplification efficiency. On the other hand, an amorphous material has a wide Raman scattering spectrum wavelength and has a feature that it is possible to widen the band of an amplification signal.

The metal part can be formed not only of single element metal but also by an addition of various elements or of an alloy. Silver can be preferably used when the wavelength of excitation light ranges from the infrared region to visible region and gold is preferably used when the wavelength of the excitation light ranges from the infrared region to approximately 500 nm and aluminum is preferably used when the wavelength of excitation light ranges from the visible region to the ultraviolet region. Furthermore, adding elements such as yttrium, neodymium, tungsten, palladium, bismuth, antimony, molybdenum to silver or gold allows the roughness of the metal part to be controlled. For example, neodymium has an action of smoothing the surface of silver. This is considered attributable to the fact that neodymium suppresses scattering of silver and reduces the size of crystalline particles.

With reference now to the attached drawings, embodiments of the present invention will be explained in detail below.

### First Embodiment

(Structure)

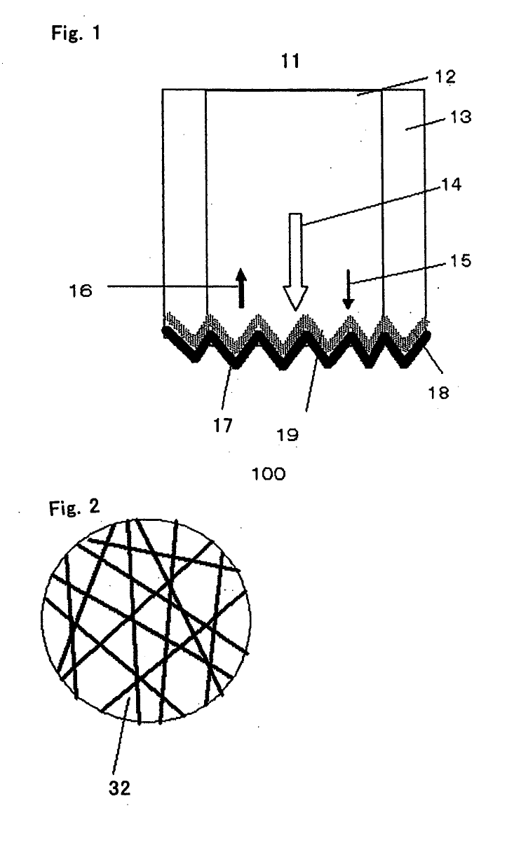

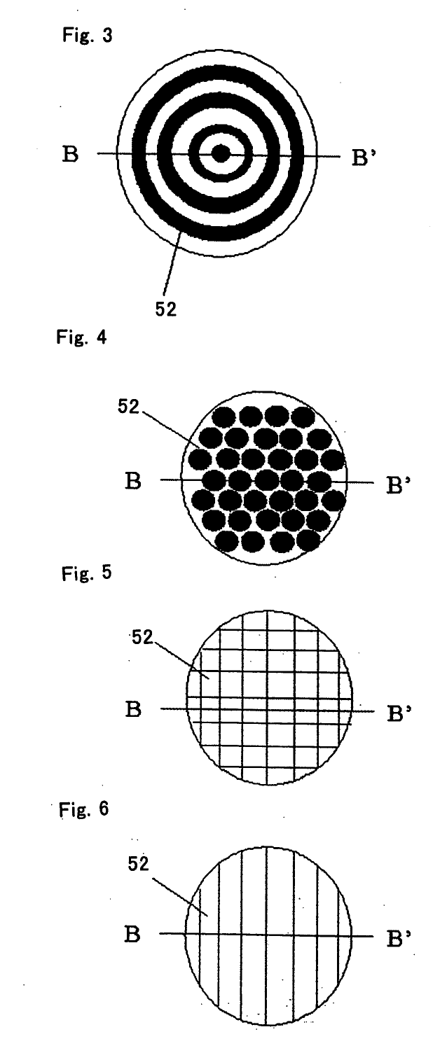

FIG. 1 shows the cross-sectional structure of a first embodiment of a light amplifier 100 of the present invention. According to FIG. 1, an end face 19 of an optical fiber 11 is made into a rough surface and a Raman active section 18 and metal part 17 are formed on the end face 19. Excitation light 14 and signal light 15 are irradiated onto the metal part 17 through the end face 19 and Raman active section 18. As shown in FIG. 2, the end face 19 is made up of an end face of random rough surface 32 having random roughness or an end face of periodic rough surface 52 having periodic roughness as shown in FIG. 3. Since the metal part 17 and Raman active section 18 are formed substantially following the shape of the end face 19, their surface and interface also have random or periodic roughness. The material of the Raman active section 18 will be explained later.

The roughness expressed here refers to a depth 34 which ranges from 1 nm to approximately a wavelength of light (e.g., from 200 nm of ultraviolet light to 10 micron of infrared light). Furthermore, in the case of periodic rough surface end face 30, the period 33 also has a range equivalent to the depth 34 (from 1 nm to approximately the wavelength of light).

When the excitation light 14 is irradiated onto the metal part 17, surface plasmon is excited on the surface of the metal part, the signal light 15 is amplified in the interface with the Raman active section 18 and an amplified signal light 16 is obtained. Here, on the end face of periodic rough surface 52, surface plasmon resonates due to a periodic structure and the degree of amplification of the signal light 15 further increases.

In addition to the concentric shape as shown in FIG. 3, the shape of the periodic rough surface end face includes various types of structure such as dot-sequential shape as shown in FIG. 4, tetragonal lattice shape as shown in FIG. 5, slit-shape as shown in FIG. 6, polyhedron lattice shape as shown in FIG. 8, fractal structure represented by the dendritic shape as shown in FIG. 9 and FIG. 10.

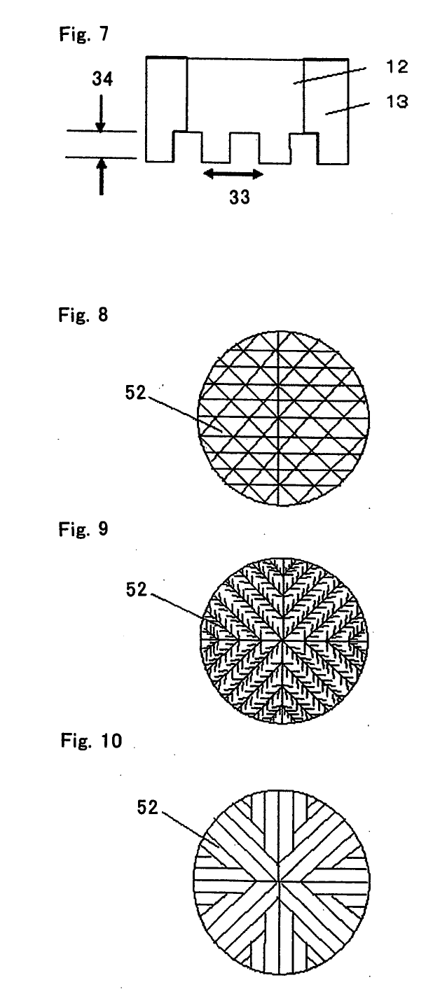

The cross-section along B-B′ of the periodic structure has convexo-concave grooves as shown in FIG. 7 and the period 33 and depth 34 are most preferably approximately the wavelength of the excitation light 14. Furthermore, the degree of amplification varies depending on the magnitude of the real part and imaginary part of the dielectric constant of the material of the metal part 17, silver has the strongest amplification, followed by gold, copper or aluminum or chromium, in that order. Platinum, rhodium, lithium, sodium, potassium, indium and palladium are also effective though their efficiency is low. Furthermore, an alloy of the above described metals is also effective.

Furthermore the metal part 17 is made of silver, gold, platinum, or aluminum or oxide, sulfide formed on the surface thereof or a mixture thereof or silver, gold or platinum and nickel, cobalt, copper, zinc, lead, thallium, mercury formed on the surface thereof or a mixture thereof or silver, gold, copper, aluminum including at least one of scattering suppression elements which or an alloy thereof. The scattering suppression element is yttrium, neodymium, tungsten, palladium, bismuth, antimony, molybdenum or an alloy thereof.

The excitation light 14 has a shorter wavelength than the signal light 15 and the difference (Raman shift) between the two wavelengths varies depending on the material of the Raman active section 18. That is, for the Raman active section 18 is a thin film, and it is possible to use single crystal silicon, amorphous silicon, graphite, amorphous carbon, diamond, diamond-shaped carbon, fullerene, carbon nanotube, germanium, silica glass, aluminum oxide, titanium oxide, beryllium oxide, magnesium oxide, indium tin oxide, calcium fluoride, sodium fluoride, lead fluoride, barium fluoride, magnesium fluoride, lanthanum fluoride, lithium fluoride, calcium carbonate, silicon carbide, potassium tantalate, calcium tungstate, arsenic trisulfide glass, magnesium germanide, germanium-selenium-tellurium glass, magnesium siliconide, selenium, zinc selenide, cadmium selenide, arsenic selenide, spinel, thallium bromide, cesium bromide, potassium bromide, thallium bromide/iodide, potassium iodide, cerium iodide, zinc sulfide, cadmium sulfide, indium phosphide or gallium arsenic, dielectric, ferroelectric substance, organic solid body containing polymeric material, etc., and can be selected according to the wavelength of the signal light and amplification wavelength band. The Raman active section 18 is a thin film containing a transparent ferroelectric substance and the transparent ferroelectric substance is transparent ferroelectric substance is a thin film containing lithium niobate, lithium tantalate, lead titanate, lead titanate zirconate, lead lanthanum titanate zirconate, strontium titanate or barium titanate.

Furthermore the Raman active section is an organic compound thin film having a lone electron-pair or having a lone electron-pair which has a functional group containing nitrogen, oxygen or sulfur or having π electrons.

(Manufacturing Method)

Next, the manufacturing method according to a first embodiment will be explained with reference to FIG. 1. A cross section is formed by polishing an end face of the optical fiber 11, the Raman active section 18 is formed and then the metal part 17 is formed. To form the Raman active section or the metal part, various film formation methods are available such as a sputtering method, vapor deposition method, chemical vapor deposition method, plating method and application method. When the end face of random rough surface 32 is formed, a surface having arbitrary roughness is formed by changing the fineness of abrasive grain when the end face of the optical fiber 11 is polished. When the end face of periodic rough surface 52 is formed, normal lithography steps are used. That is, a photoresist film applied to the optical fiber end face which is smoothly polished through an exposure mask prepared into a desired pattern is exposed to light and then various periodic patterns are formed by etching. Finally, by removing the extra resist, a desired pattern is formed.

### Second Embodiment

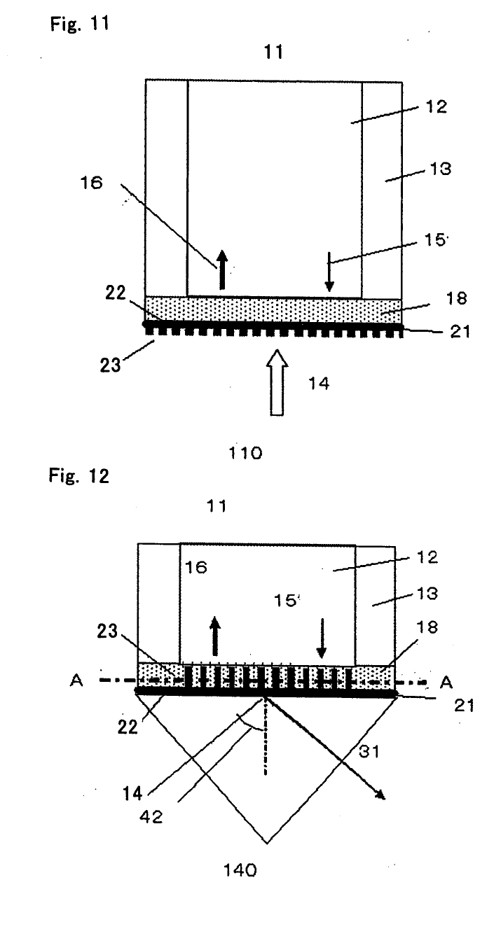

The cross-sectional structure of a light amplifier 110 according to a second embodiment of the present invention is shown in FIG. 11.

According to FIG. 11, a Raman active section 18 and a rough surface metal part 21 are formed on an end face of an optical fiber 11. The rough surface metal part 21 has a smooth surface 22 on the side contacting the optical fiber 11 and a rough surface 23 on the side facing the outside. Signal light 15 is irradiated onto the smooth surface 22 of the metal part and excitation light 14 is irradiated from the outside of the optical fiber onto the rough surface 23 of the rough surface metal part 21. What is different from the first embodiment lies in the excitation direction and the fact that one side of the rough surface metal part 21 is a smooth surface and the other side of the rough surface metal part 21 is a rough surface.

The rough surface 23 of the rough surface metal part 21 is shaped with random roughness as shown in FIG. 2 or, for example, periodic roughness as shown in FIG. 3, FIG. 4, FIG. 5, FIG. 6, FIG. 8, FIG. 9 or FIG. 10.

When the excitation light 14 is irradiated onto the rough surface 23 of the rough surface metal part 21, surface plasmon is excited, the signal light 15 is amplified in the interface between the smooth surface 22 and Raman active section 18, reflected on the smooth surface 22 of the rough surface metal part 21 producing amplified signal light 16 which travels in a direction opposite to the direction of the signal light.

Here, for the rough surface metal part 21, using a metal rough surface having periodicity instead of having a random rough surface further increases the degree of amplification. To suppress a reflection loss of amplification light and a propagation loss of surface plasmon, the smooth surface 22 of the rough surface metal part 21 is preferably made as smooth as possible, but from the standpoint of the cost of a polishing step, it is preferable to use center line average roughness (Ra) of approximately 0.01 nm to 1 nm defined in Japanese Industrial Standards B0601.

Since the light amplifier of this second embodiment is constructed in such a way that the signal light is not mixed with the excitation light, it is characterized by low loss for both the signal light and excitation light.

### Third Embodiment

The cross-sectional structure of a light amplifier 140 according to a third embodiment of the present invention is shown in FIG. 12.

According to FIG. 12, a light amplifier 140 is provided with a Raman active section 18 and a rough surface metal part 21 on an end face of an optical fiber 11. A rough surface 23 side of the rough surface metal part 21 faces the end face of the optical fiber and the surface facing the rough surface 23 is a smooth surface 22. A prism 31 is provided in contact with this surface. Through this prism 31, excitation light 14 is irradiated from the outside of the optical fiber at an angle of incidence 42.

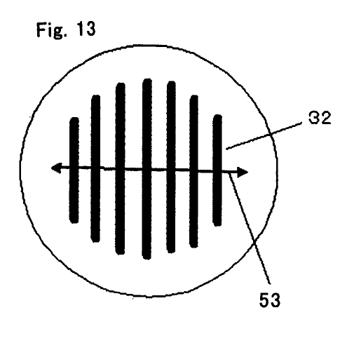

When an optimum angle of incidence 42 is selected, the excitation light is efficiently converted to surface plasmon by the rough surface metal part 21, stimulated Raman scattering occurs in the interface between the Raman active section 18 and rough surface metal part 21, and it is possible to obtain amplified signal light 16 from the signal light 15 at a large amplification factor without any mixture of the excitation light 14. A-A′ cross-section view is shown in FIG. 13.

As shown in FIG. 13, the rough surface 23 of the rough surface metal part 21 is a slit-like periodic rough surface. The traveling direction 53 of surface plasmon is parallel to the irradiation direction of the excitation light 14 and the slit arrangement direction is also preferably parallel to this. The periodic structure produces resonance of surface plasmon and a stronger amplification action allows the signal light 15 to be converted to the amplified signal light 16.

### Fourth Embodiment

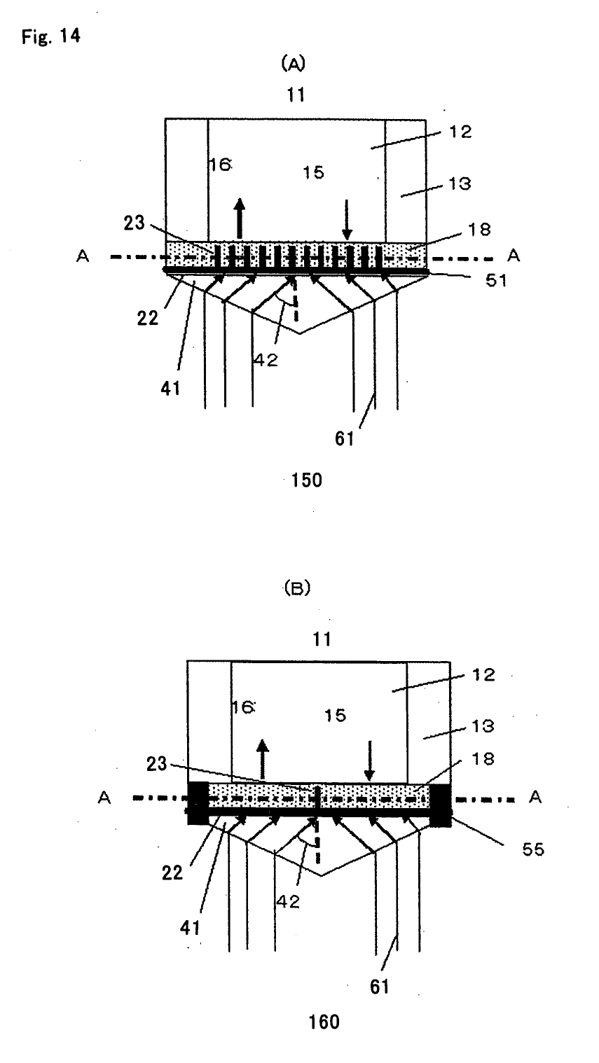

The cross-sectional structure of a light amplifier 150 according to a fourth embodiment of the present invention is shown in FIG. 14(A) and the cross-sectional structure of a light amplifier 160 of an embodiment which is similar to this is shown in FIG. 14(B).

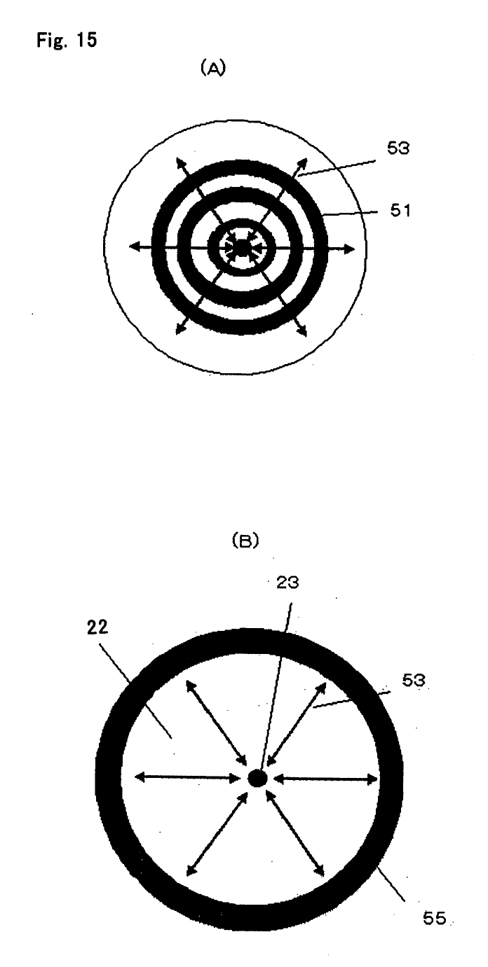

According to FIG. 14(A), the light amplifier 150 is provided with a Raman active section 18 and a periodic rough surface metal part 51 on one end face of an optical fiber 11. A rough surface 23 of the rough surface metal part 51 faces one end face of the optical fiber and the surface facing the rough surface 23 is a smooth surface 22. An axicon lens 41 is provided in contact with this surface. Through the axicon lens 41, excitation light 61 is irradiated from the outside of the optical fiber at an angle of incidence 42. A-A′ cross-section view is shown in FIG. 15(A) and (B).

As FIG. 15(A) shows the traveling direction 53 of surface plasmon, by irradiating excitation light 61 at an optimum angle of incidence 42, the excitation light 61 is efficiently converted to surface plasmon heading for the central region of the end face of the optical fiber. The converted surface plasmon strongly excites stimulated Raman scattering in the interface between the Raman active section 18 and periodic rough surface metal part 51. This causes input signal light 15 to be amplified at a greater amplification factor into amplified signal light 16 and output.

As in the case of the second embodiment, the light amplifier having this structure need not merge or separate the excitation light 61 and signal light 15, and therefore it is possible to obtain the amplified signal light 16 with less insertion loss due to merge/separation elements.

As shown in FIG. 15(A), the rough surface 23 of the periodic rough surface metal part 51 according to this embodiment has a concentric periodic structure having circles perpendicular to the irradiation direction of the excitation light. The periodic structure causes surface plasmon to resonate and allows the signal light 15 to be converted to the amplified signal light 16 through a stronger amplification action. The closer the vertex of the conic shape of the axicon lens 41 to the central part of the periodic rough surface metal part 51 having a concentric shape/structure in FIG. 15, the more efficiently it is possible to convert the signal to surface plasmon.

This embodiment may also be modified as shown in FIG. 14(B).

According to FIG. 14(B), the light amplifier 160 is provided with a Raman active section 18 on one end face of the optical fiber 11 and a metal wall 55 having a single protruding rough surface in the center. The rest of the configuration is the same as that of the light amplifier 150 in FIG. 14(A).

Irradiating the excitation light 61 at an optimum angle of incidence 42 causes the excitation light 61 to be efficiently converted to surface plasmon concentrated on the central part of the end face of the optical fiber as shown in FIG. 15(B). This converging surface plasmon produces stimulated Raman scattering in the interface between the Raman active section 18 and protruding rough surface 28 in the central part more strongly, which causes the incident signal light 15 to be amplified at a greater amplification factor and output as high output amplified signal light 16.

### Fifth Embodiment

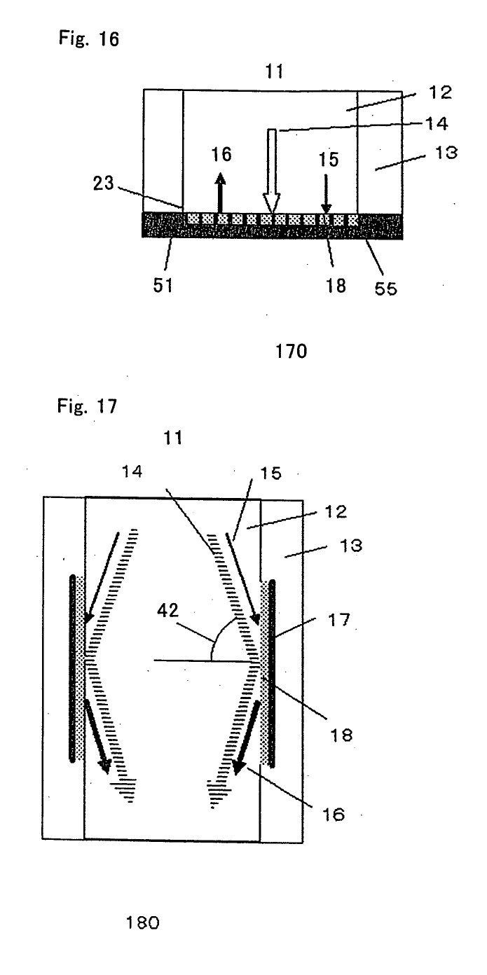

The cross-sectional structure of a light amplifier 170 according to a fifth embodiment of the present invention is shown in FIG. 16.

According to FIG. 16, the light amplifier 170 is provided with a Raman active section 18 formed in a rough surface 23 of a periodic rough surface metal part 51 provided on a smooth end face of an optical fiber 11. Signal light 15 is amplified by stimulated Raman scattering produced in the interface between the Raman active section 18 and periodic rough surface metal part 51 by excitation light 14 introduced from the optical fiber side into the Raman active section 18.

In the light amplifier of this embodiment, the periodic rough surface metal part 51 includes periodically arranged metal wall 55. Since surface plasmon excited by the periodic rough surface metal part 51 is reflected on this periodic metal wall 55, resonance of surface plasmon becomes stronger and stimulated Raman scattering is also enhanced.

### Sixth Embodiment

The cross-sectional structure of a light amplifier 180 according to a sixth embodiment of the present invention is shown in FIG. 17.

According to FIG. 17, the light amplifier 180 is provided with a Raman active section 18 and a metal part 17 formed in the interface between a core 12 and a clad 13 of an optical fiber 11.

Signal light 15 is reflected on the metal part 17 while being amplified repeatedly by stimulated Raman scattering in the interface between the Raman active section 18 and metal part 17 and output as strong amplified signal light 16. To suppress light scattering loss and propagation loss of surface plasmon, the metal part 17 is preferably prepared as smooth as possible, but from the standpoint of the cost of the polishing step, it is preferable to use center line average roughness (Ra) of approximately 0.01 nm to 1 nm defined in Japanese Industrial Standards B0601. In this embodiment, the excitation light 14 is irradiated onto the metal part 17 at various angles of incidence 42, but excitation light of an angle at which it can be converted to surface plasmon most easily gets involved in light amplification.

### Seventh Embodiment

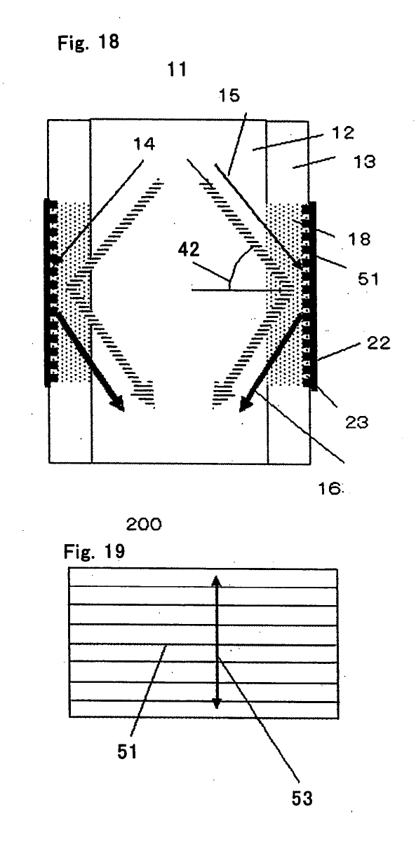

The cross-sectional structure of a light amplifier 200 according to a seventh embodiment of the present invention is shown in FIG. 18.

According to FIG. 18, in the light amplifier 200, part of a clad of an optical fiber 11 is constructed of a Raman active section 18 and a periodic rough surface metal part 51 is formed outside the Raman active section.

Signal light 15 propagating through the core 12 is amplified by stimulated Raman scattering through surface plasmon by excitation light 14 which has propagated through the same core 12 in the interface between the Raman active section 18 and a rough surface 23 of the periodic rough surface metal part 51 and output as strong amplified signal light 16.

The light amplifier 200 can take a greater thickness of the Raman active section 18 than the light amplifier 180 and allows light amplification by greater stimulated Raman scattering. Furthermore, generation of a resonance state of surface plasmon on the rough surface 23 of the periodic rough surface metal part 51 allows light-amplification by greater stimulated Raman scattering.

As shown in FIG. 19, when the signal light 15 and excitation light 14 are irradiated onto the periodic rough surface metal part 51, surface plasmon is excited and when a traveling direction 53 of surface plasmon is parallel to the periodic arrangement direction of the periodic rough surface, light amplification by greater stimulated Raman scattering is possible through resonance of surface plasmon.

Furthermore, the periodic rough surface metal part 51 is not limited to the simple bamboo blind shape as shown in FIG. 19, but includes various types of structure such as a polyhedron lattice shape, dot-sequential shape, dendritic shape, etc. The cross-section of the periodic rough surface metal part 51 has convexo-concave grooves as shown in FIG. 7 above and the period 33 and depth 34 thereof are most preferably on the order of the wavelength of the excitation light 14.

Furthermore, the extent of amplification varies depending on the material of the periodic rough surface metal part 51 and it is preferable to select the same metal material as the metal part 17 used for the light amplifier 100.

The required wavelength of the excitation light 14 is shorter than the wavelength of the signal light 15, the difference in the wavelength (Raman shift) varies depending on the material of the Raman active section 18 and it is possible to select the same material as that of the Raman active section 18 used for the light amplifier 100.

### Eighth Embodiment

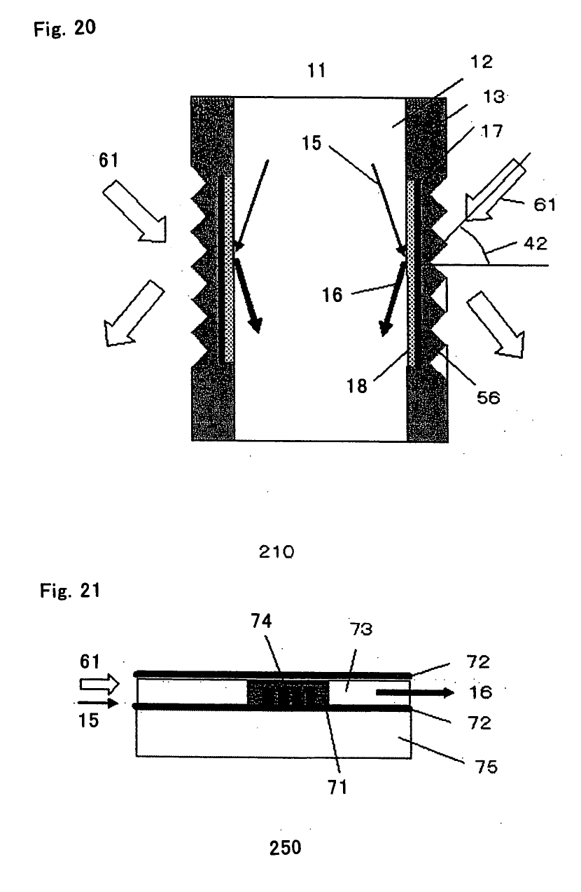

The cross-sectional structure of a light amplifier 210 according to an eighth embodiment of the present invention is shown in FIG. 20.

According to FIG. 20, a light amplifier 210 is provided with a Raman active section 18 and a metal part 17 formed in the interface between a core 12 and a clad 13 of an optical fiber 11. A rough clad section 56 is provided on the outer surface of the clad.

Excitation light 61 is irradiated onto a metal part 17 from the outside through the rough clad section 56 at an angle of incidence 42 and converted to surface plasmon. Signal light 15 which has propagated through the core 12 of the optical fiber 11 is amplified by stimulated Raman scattering through surface plasmon in the interface between the Raman active section 18 and metal part 17 and output as strong amplified signal light 16.

Slopes are formed in the rough clad section 56 at an angle of incidence 42 so that excitation light 61 can enter at right angles. Suppose the angle of incidence 42 is θ, refractive index of the clad 13 is n, dielectric constant of the metal part 17 is ε1 and dielectric constant of the Raman active section 18 is ε2. Then, θ can be expressed by the following expression:
θ=sin⁻¹(1/n×(ε1ε2/(ε1+ε2))1/2) (1)

θ effectively takes a value from 5 degrees to 85 degrees.

In order to suppress light scattering loss and propagation loss of surface plasmon, the metal part 17 is preferably prepared as smooth as possible, but from the standpoint of the cost of the polishing step, it is preferable to use center line average roughness (Ra) of approximately 0.01 nm to 1 nm defined in Japanese Industrial Standards B0601. In this embodiment, the excitation light 61 can be irradiated at an angle of incidence 42 and therefore it is possible to select an angle at which it can be converted to surface plasmon most efficiently.

### Ninth Embodiment

The cross-sectional-structure of a light amplifier 250 according to a ninth embodiment of the present invention is shown in FIG. 21.

According to FIG. 21, a waveguide type light amplifier 250 adopts a waveguide structure which guides excitation light 61 and signal light 15 through a dielectric waveguide film 73 sandwiched between a substrate 75 and a metal film 72 formed on a substrate 75. A periodic rough surface metal film 74 coated with a Raman active film 71 is formed at some midpoint of the dielectric waveguide film 73.

When the excitation light 61 and signal light 15 enter the periodic rough surface metal film 74, surface plasmon is excited in the interface between the Raman active film 71 and periodic rough surface metal film 74 and the signal light 15 is amplified by strong stimulated Raman scattering. The metal film 72 plays the role of preventing outward scattering of the signal light amplified by the Raman active film 71 and trapping the signal light in the dielectric waveguide film 73. Furthermore, the metal film 72 that covers the dielectric waveguide film 73 except the portion corresponding to the Raman active film 71 converts the excitation light component of the excitation light 61 component which is reflected on the surface of the metal film at a specific angle to surface plasmon. When surface plasmon which has propagated over the surface of the converted metal film 72 reaches the Raman active film 71, it amplifies the signal light 15 and further contributes to the strengthening of Raman amplification in addition to light amplification at the periodic rough surface metal film 74. The specific angle means an angle that satisfies Expression (1) explained in the sixth embodiment. n in Expression (1) gives a refractive index of the dielectric waveguide film 73 here.

### Tenth Embodiment

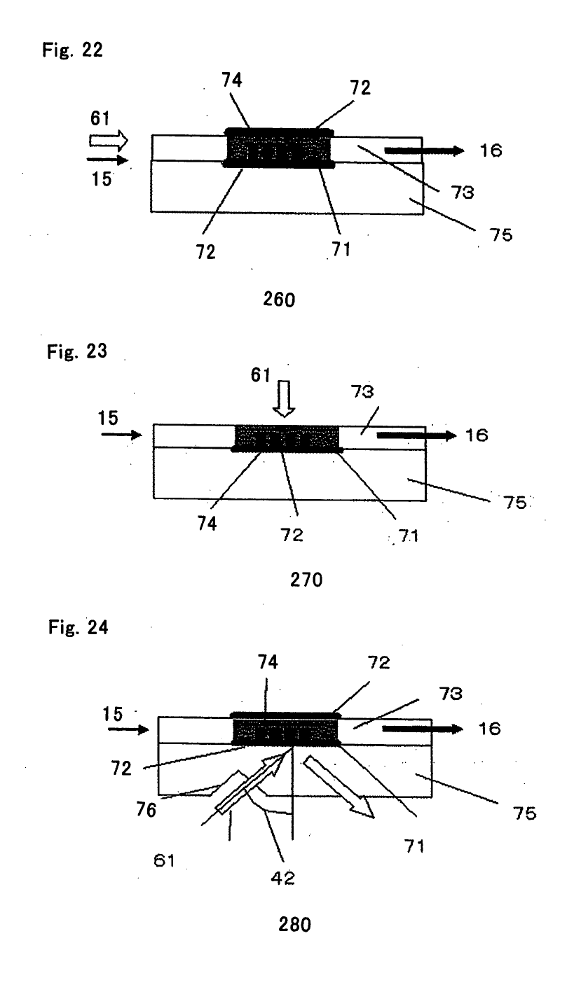

The cross-sectional structure of a light amplifier 260 according to a tenth embodiment of the present invention is shown in FIG. 22.

According to FIG. 22, the waveguide type light amplifier 260 consists of a dielectric waveguide film 73 formed on a substrate 75 and a periodic rough surface metal film 74 coated with a Raman active film 71 formed at some midpoint of the waveguide. This part is sandwiched between metal films 72.

When excitation light 61 and signal light 15 are irradiated onto the periodic rough surface metal film 74, surface plasmon is excited in the interface between the Raman active film 71 and periodic rough surface metal film 74 and signal light 15 is amplified by strong stimulated Raman scattering. The metal film 72 plays the role of preventing outward scattering of signal light amplified by the Raman active film 71 and trapping the signal light in the dielectric waveguide film 73.

Here, the refractive index of the dielectric waveguide film 73 is greater than the refractive index of the substrate 75 making it possible to trap the excitation light 61 and signal light 15 through total reflection. For example, SiO2 is used for the substrate 75 and SiO2 with GeO2 added is used for the dielectric waveguide film 73. Furthermore, as the method of trapping and guiding light, it is also possible to use a photonic crystal structure as disclosed in “Solid Physics” (Susumu Noda, 2002, Vol. 37, No. 5, pp 335-343). The materials of the metal film 72, periodic rough surface metal film 74 and Raman active film 71 are the same as the materials disclosed in the explanation of the manufacturing method of the light amplifier 100 of the first embodiment.

### Eleventh Embodiment

The cross-sectional structure of a light amplifier 270 according to an eleventh embodiment of the present invention is shown in FIG. 23.

According to FIG. 23, the waveguide type light amplifier 270 consists of a dielectric waveguide film 73 formed on a substrate 75 and a periodic rough surface metal film 74 coated with a Raman active film 71 formed at some midpoint of the waveguide. This part includes a metal film 72 in the interface with the substrate. Excitation light 61 is introduced from the upper clad.

When the excitation light 61 is irradiated from the outside onto the periodic rough surface metal film 74 which is formed at some midpoint of the dielectric waveguide film 73 and coated with the Raman active film 71, surface plasmon is excited in the interface between the Raman active film 71 and periodic rough surface metal film 74 and signal light 15 is amplified by strong stimulated Raman scattering. The metal film 72 plays the role of reflecting the excitation light 61 and amplified signal light 16 and reducing losses.

### Twelfth Embodiment

The cross-sectional structure of a light amplifier 280 according to a twelfth embodiment of the present invention is shown in FIG. 24.

According to FIG. 24, the waveguide type light amplifier 280 consists of a dielectric waveguide film 73 formed on a substrate 75 and a periodic rough surface metal film 74 coated with a Raman active film 71 formed at some midpoint of the waveguide. This part is sandwiched between metal films 72. Excitation light 61 is introduced from the substrate 75 side.

When excitation light 61 is irradiated from the substrate side onto the periodic rough surface metal film 74 which is sandwiched by the metal films 72 formed at some midpoint of the dielectric waveguide film 73 and coated with the Raman active film 71 at an angle of incidence 42, surface plasmon is efficiently excited in the interface between the Raman active film 71 and periodic rough surface metal film 74 and signal light 15 is amplified by strong stimulated Raman scattering. The excitation light is introduced into the substrate through the incident light groove 76 having a slope angle corresponding to the angle of incidence 42. The metal film 72 plays the role of preventing outward scattering of signal light amplified by the Raman active film 71 and trapping the signal light in the dielectric waveguide film 73.

### Thirteenth Embodiment

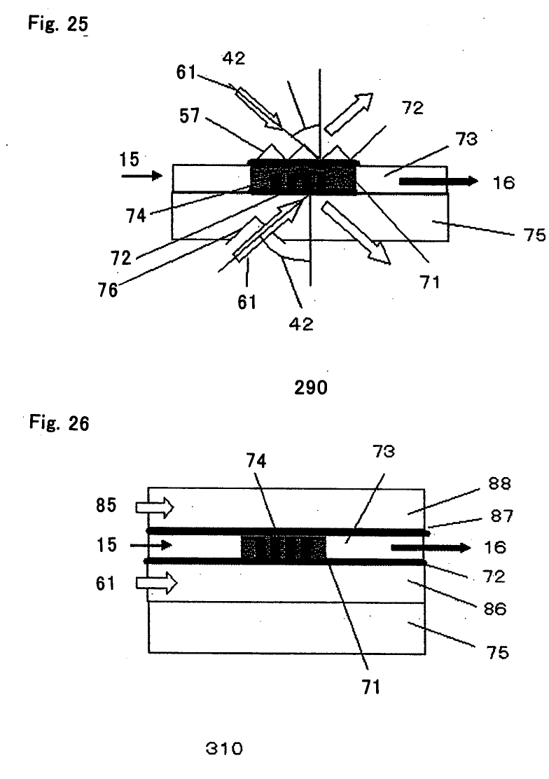

The cross-sectional structure of a light amplifier 290 according to a thirteenth embodiment of the present invention is shown in FIG. 25.

According to FIG. 25, the waveguide type light amplifier 290 consists of a dielectric waveguide film 73 formed on a substrate 75 and a periodic rough surface metal film 74 coated with a Raman active film 71 formed at some midpoint of the waveguide. This part is sandwiched between metal films 72 and is further provided with a rough dielectric section 57. Excitation light 61 is introduced from both the substrate 75 side and the rough dielectric section 57.

When excitation light 61 is irradiated from the outside of the substrate onto the periodic rough surface metal film 74 at an angle of incidence 42 and at the same time, excitation light is irradiated onto the metal film 72 at an angle of incidence 42 through another rough dielectric section 57. This allows surface plasmon to be efficiently excited in the interface between the Raman active film 71 and periodic rough surface metal film 74 and allows signal light 15 to be amplified by strong stimulated Raman scattering. The excitation light is introduced into the substrate 75 through the incident light groove 76 having a slope angle corresponding to the angle of incidence 42. The slope angle of the rough dielectric section 57 is the same as the angle of incidence 42. The metal film 72 plays the role of preventing outward scattering of signal light amplified by the Raman active film 71 and trapping the signal light in the dielectric waveguide film 73. The material of the rough dielectric section 56 can be any dielectric if it is at least transparent in the wavelength band of the excitation light, but it is possible to use, for example, quartz and optical glass.

### Fourteenth Embodiment

The cross-sectional structure of a light amplifier 310 according to a fourteenth embodiment of the present invention is shown in FIG. 26.

According to FIG. 26, the waveguide type light amplifier 310 adopts a three-layer waveguide structure with a dielectric waveguide film 86, a dielectric waveguide film 73 and a dielectric waveguide film 88 formed on a substrate 75. The dielectric waveguide film 73 has a structure with the interface between the upper and lower dielectric waveguide films 86, 88 sandwiched by metal films 72. Furthermore, a periodic rough surface metal film 74 coated with a Raman active film 71 is formed at some midpoint of the dielectric waveguide 73. The dielectric waveguide film 73 guides signal light, the dielectric waveguide film 86 guides excitation light 61 and the dielectric waveguide film 88 guides excitation light 85.

The excitation light 61 and excitation light 85 excite surface plasmon in the metal film 72 and metal film 87 respectively. When propagating surface plasmon reaches the periodic rough surface metal film 74 coated with the Raman active film 71 sandwiched between the metal film 72 and metal film 87 formed at some midpoint of the dielectric waveguide film 73, surface plasmon efficiently resonates in the interface between the Raman active film 71 and periodic rough surface metal film 74. This produces strong stimulated Raman scattering and amplifies signal light 15.

When the excitation light 61 and other excitation light 85 having an identical wavelength are selected, the amplification factor of the signal light 15 doubles, but if the two lights with different wavelengths are selected, it is possible to amplify signal light with multiple wavelengths of different bands.

### Fifteenth Embodiment

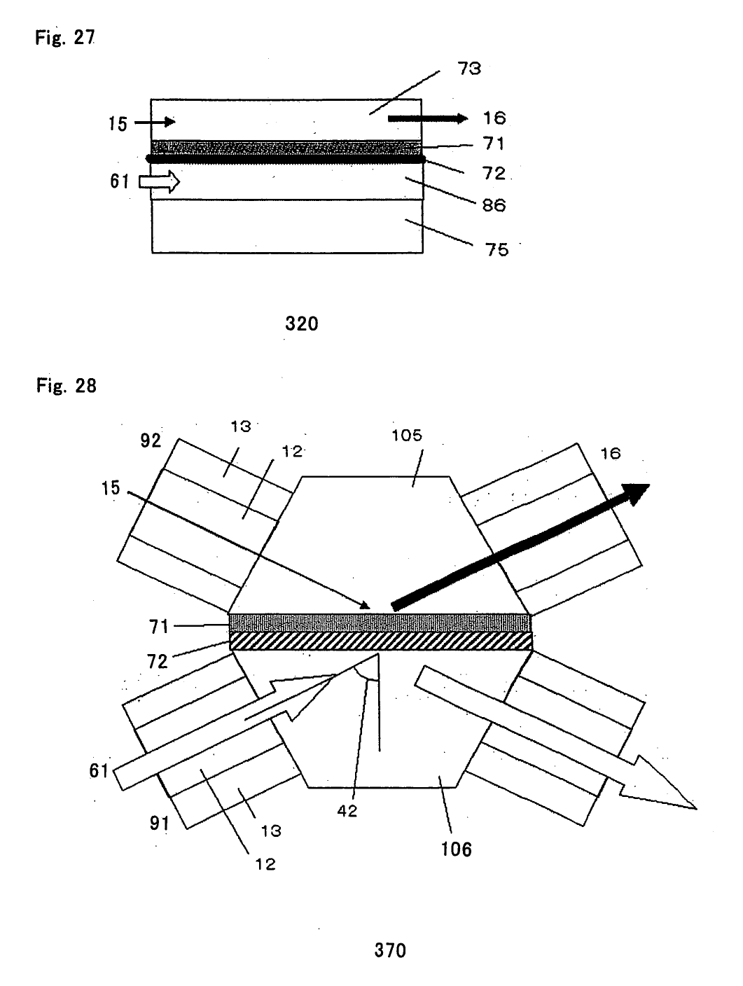

The cross-sectional structure of a light amplifier 320 according to a fifteenth embodiment of the present invention is shown in FIG. 27.

According to FIG. 27, the waveguide type light amplifier 320 has a dielectric waveguide film 86 formed on a substrate 75 coated with a Raman active film 71 separated by a metal film 72 and another dielectric waveguide film 73 disposed thereon. The interfaces between the metal film 72 and dielectric waveguide film 86, and Raman active film 71 are smooth.

The dielectric waveguide film 73 guides signal light 15 and the dielectric waveguide film 86 guides excitation light 61.

While being guided through the dielectric waveguide film 86, the excitation light 61 excites surface plasmon in the metal film 72.

Propagating surface plasmon produces stimulated Raman scattering in the interface with the Raman active film 71 and amplifies signal light 15. The signal light 15 is always amplified by the excitation light 61 while being guided, and therefore it is possible to prevent attenuation of the signal light 15 even if there is no strong stimulated Raman scattering by the periodic rough surface metal film. Furthermore, since the signal light 15 and excitation light 61 are not mixed, it is possible to prevent deterioration of signal quality due to multiplexing and demultiplexing.

### Sixteenth Embodiment

The cross-sectional structure of a light amplifier 370 according to a sixteenth embodiment of the present invention is shown in FIG. 28.

According to FIG. 28, a prism-like light amplifier 370 includes two reflective prisms 105 and 106 with reflecting surfaces bonded together and a metal layer 72 and a Raman active layer 71 on the bonded surface. End faces of a signal optical fiber 92 are connected to light input/output surfaces of the prism 105 and end faces of an excitation optical fiber 91 are connected to light input/output surfaces of the prism 106.

When excitation light 61 which propagates through the excitation optical fiber 91 is irradiated onto the metal layer 72 at an angle of incidence 42, surface plasmon is excited in the metal layer 72. The excited surface plasmon provokes strong stimulated Raman scattering in the interface between the metal layer 72 and Raman active layer 71. This stimulated Raman scattering causes the signal light 15 that enters the prism 105 from the signal optical fiber 92 to be amplified and output as amplified signal light 16 when the signal light 15 is reflected on the metal layer 72 through the Raman active layer 71.

### Seventeenth Embodiment

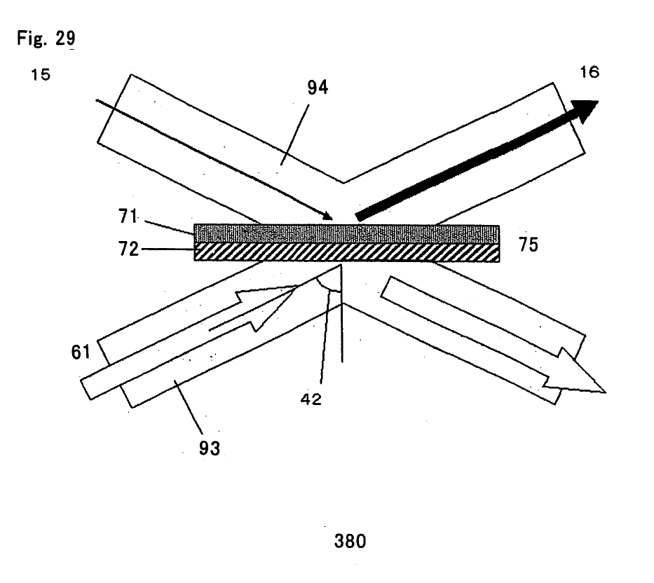

The flat structure of a light amplifier 380 according to a seventeenth embodiment of the present invention is shown in FIG. 29.

According to FIG. 29, the flat waveguide type light amplifier 380 is constructed of flat waveguides which replace the prism sections of the prism-like light amplifier in FIG. 28.

When excitation light 61 propagating through an excitation flat waveguide 93 formed on a substrate 75 is irradiated onto a metal layer 72 at an angle of incidence 42, surface plasmon is excited by the metal layer 72. When stimulated Raman scattering is generated in the interface between the metal layer 72 and Raman active layer 71 by surface plasmon and signal light 15 propagating through a signal flat waveguide 94 is reflected on the metal layer 72 through the Raman active layer 71, the signal light 15 is amplified, producing amplified signal light 16.

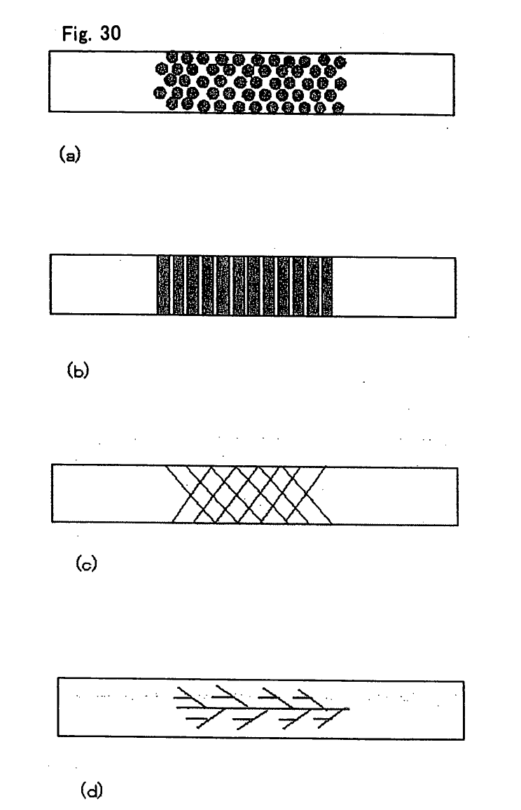

As examples of the structure of the periodic rough surface metal film used for the waveguide type light amplifiers 250, 260, 270, 280, 290 and 310, there are shapes shown in FIG. 30. FIG. 30(a) shows a dotted-sequence shape, (b) shows a slit shape, (c) shows a lattice shape and (d) shows a dendritic shape.

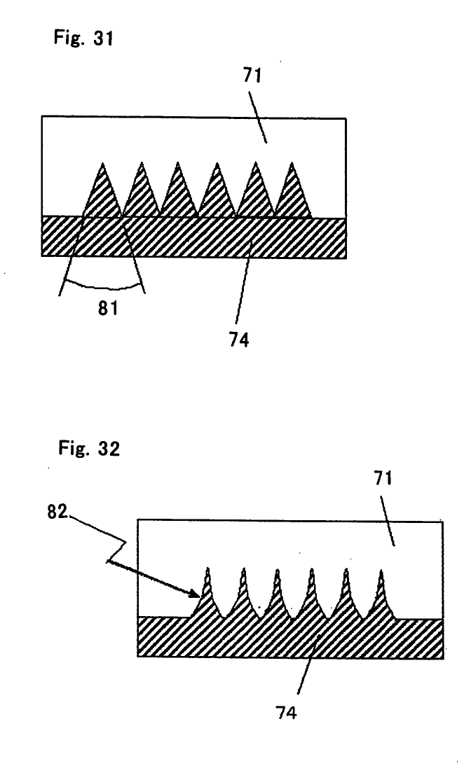

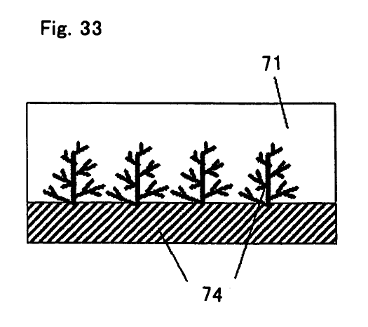

The cross-sectional structures of the rough surface metal part 21 of the light amplifier 110,1 40, the periodic rough surface metal part 51 of the light amplifier 150, 170 and the periodic rough surface metal film 74 of the waveguide type light amplifier 250, 260, 270, 280, 290, 310 are not limited to the square shape shown in the aforementioned embodiments, but there are a sawtooth-shaped structure(vertex angle 81) as shown in FIG. 31 and string-shaped structure(curvature radius 82) as shown in FIG. 32 or a dendritic structure as shown in FIG. 33. In these structures, an electric field is likely to concentrate on a tip, allowing a stronger light amplification action.

Next, the manufacturing method of the second embodiment shown in FIG. 11 will be explained.

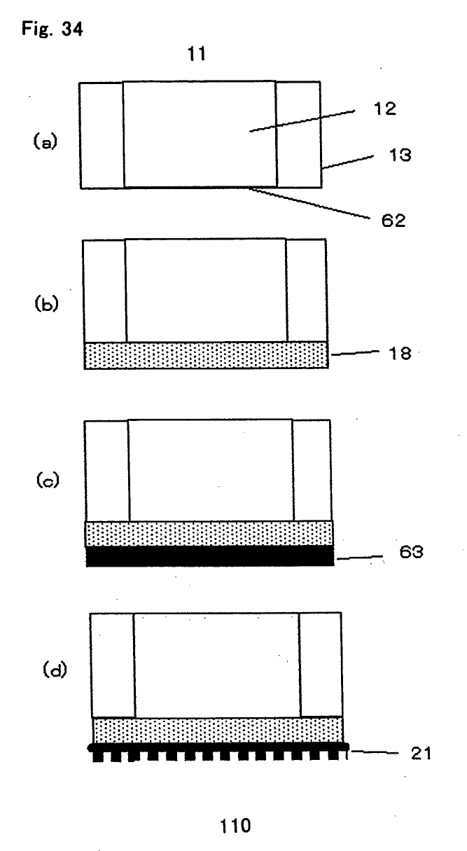

As shown in FIG. 34, one end face of the optical fiber 11 is polished into a polished surface 62, the polished surface is coated with silicon as a Raman active material using a sputtering method and the Raman active section 18 is formed. Next, the Raman active section 18 is coated with silver as the metal material and a metal part 63 is formed through sputtering. Then, the metal part 63 is processed using a normal photolithography method into the rough surface metal part 21. That is, a photoresist film applied to the metal part 63 through an exposure mask created in a desired pattern is exposed to light, then a variety of periodic patterns are formed by etching. Finally, extra resists are removed and the desired pattern is thereby formed and the light amplifier 110 is created.

Next, the manufacturing method according to the sixth embodiment shown in FIG. 17 will be explained.

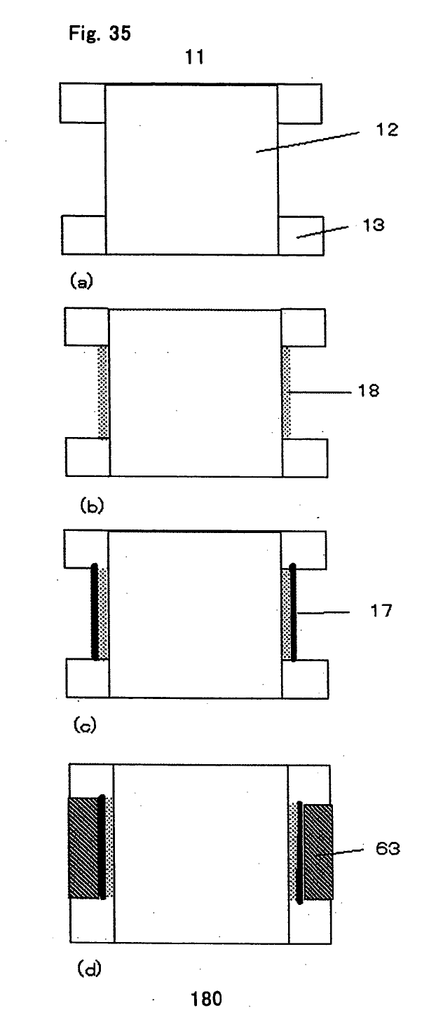

As shown in FIG. 35, part of the clad 13 on one side of the optical fiber 11 is removed by etching so that the core 12 is exposed. Next, the exposed core is coated with silicon as a Raman active material to form the Raman active section 18, then coated with silver as a metal material through sputtering to form the metal part 17. Finally, the metal part 17 is coated with a reinforcement agent of the same material as the clad material or resin, etc., to create the light amplifier 180.

Next, the manufacturing method according to the ninth embodiment shown in FIG. 21 will be explained.

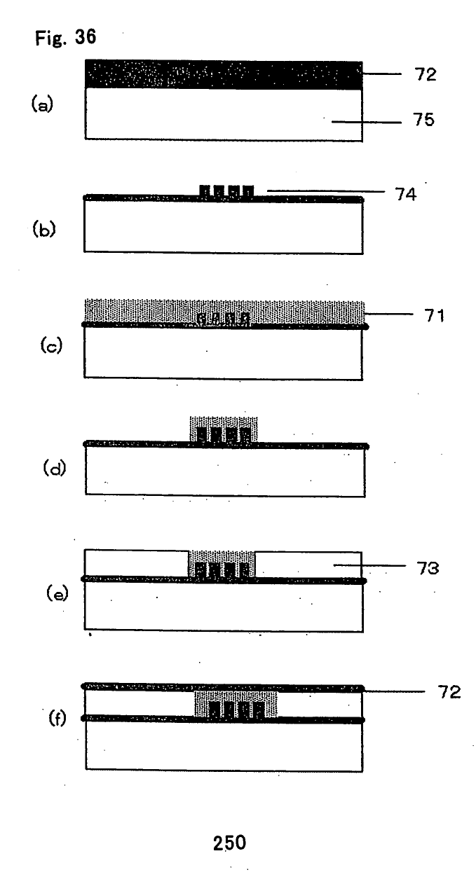

As shown in FIG. 36, silver is prepared on the silicon substrate selected as the substrate 75 as the metal film 72 through sputtering and then the periodic rough surface metal film 74 is formed using a photolithography method. The metal film 74 is coated with lead titanate zirconate as the Raman active film 71 using the sputtering method. Next, the structure as shown in FIG. 36(d) with the periodic rough surface metal film coated with the Raman active film is formed using a photolithography method. Furthermore, SiO2 is formed thereon as the dielectric waveguide film through sputtering and finally coated with silver as the metal film 72 using the sputtering method and the flat waveguide type light amplifier 250 is thereby created.

Next, the manufacturing method of the sixteenth embodiment in FIG. 28 will be explained.

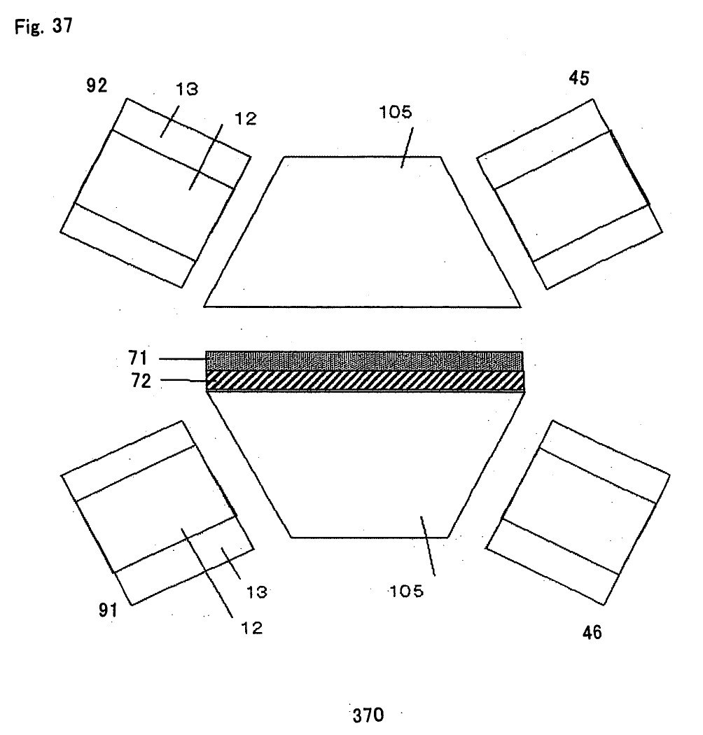

As shown in FIG. 37, the two quartz trapezoidal prisms 105 are prepared, one is coated with silver as the metal film 72 and further coated with a lanthanum lead titanate zirconate thin film as the Raman active layer 71 through sputtering. Furthermore, the signal light fibers 92 and 45 and excitation optical fibers 91 and 46 whose end faces have been polished smoothly are prepared and bonded together using adhesives having the same refractive index and the optical fiber light amplifier 370 is thereby created.

Next, the manufacturing method according to the seventeenth embodiment in FIG. 29 will be explained.

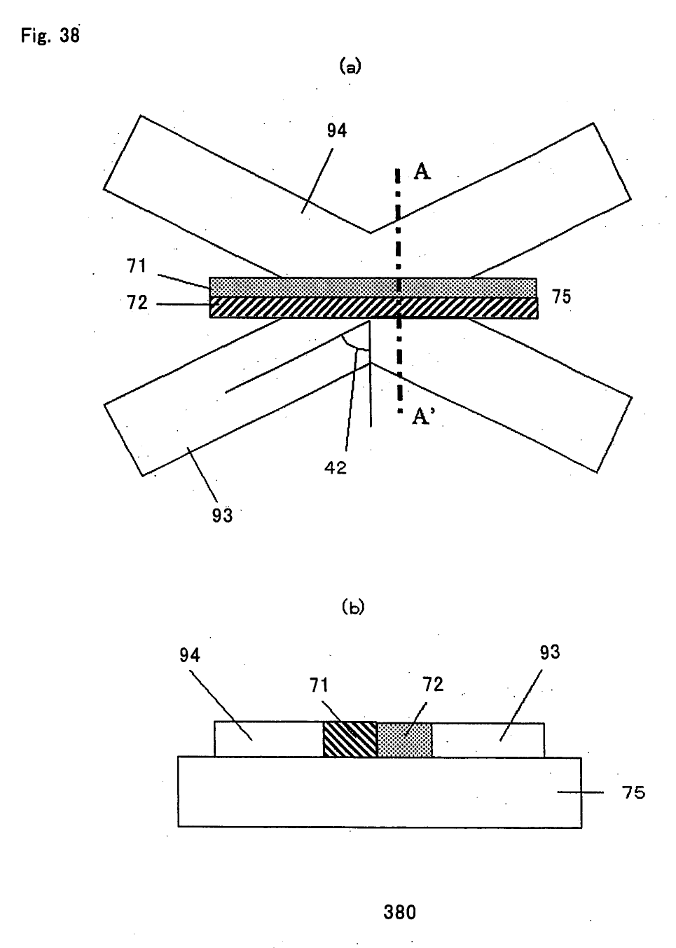

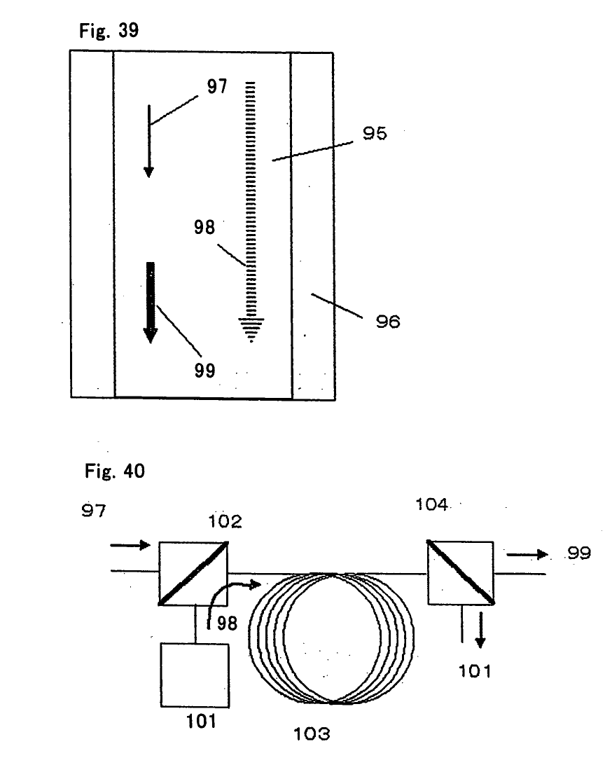

As shown in FIG. 38, a titanium dioxide thin film is formed on the quartz substrate 75 and then the signal flat waveguide 94 and excitation flat waveguide 93 are formed using the photolithography method. Next, carbon is coated as the Raman active film 71 using the sputtering method, the Raman active layer 71 is formed using the photolithography method, coated with silver as the metal layer 72 using the sputtering method and formed using the photolithography method and the flat waveguide type light amplifier 380 is thereby created.

The present invention is not limited to the above described embodiments and it is obvious that the respective embodiments can be modified as appropriate within the scope of the technological thought of the present invention.

Application examples of the present invention include light amplifiers used for optical wiring for optical communication and optical wiring between computer electronic circuit boards, optical wiring between integrated electronic circuits, optical wiring in an integrated electronic circuit or all-optical integrated circuit.

1. A light amplification element having a structure comprising a metal part having a negative dielectric constant and a Raman active section arranged adjacent to each other.

2. The light amplification element according to claim 1, wherein the interface between said metal part and said Raman active section has a rough surface.

3. The light amplification element according to claim 2, wherein the convexo-concave structure forming said rough surface has periodicity.

4. The light amplification element according to claim 2, wherein said rough surface includes a shape and array having a fractal structure.

5. The light amplification element according to claim 1, wherein said metal part has a rough surface.

6. The light amplification element according to claim 5, wherein said metal part rough surface has a micro shape and array having a diameter of 100 nm or less and the closest distance of the respective micro shape and array ranges from 0.5 nm to 50 nm.

7. The light amplification element according to claim 5, wherein said metal part rough surface has periodically formed concentric grooves.

8. The light amplification element according to claim 5, wherein said metal part rough surface includes a periodically formed fractal structure.

9. The light amplification element according to claim 5, wherein the convexo-concave structure forming said metal part rough surface includes a convex section having a vertical angle of 90 degrees or less.

10. The light amplification element according to claim 5, wherein the convexo-concave structure forming said metal part rough surface has periodicity and forms a hexagonal array.

11. The light amplification element according to claim 1, wherein said metal part is made of silver, gold, copper, platinum, aluminum, chromium, rhodium, lithium, sodium, potassium, indium, palladium or one or more of two or more types of alloy of metals selected from said metals.

12. The light amplification element according to claim 1, wherein said metal part is made of silver, gold, platinum, or aluminum or oxide, sulfide formed on the surface thereof or a mixture thereof.

13. The light amplification element according to claim 1, wherein said metal part is made of silver, gold or platinum and nickel, cobalt, copper, zinc, lead, thallium, mercury formed on the surface thereof or a mixture thereof.

14. The light amplification element according to claim 1, wherein said metal part is made of silver, gold, copper, aluminum including at least one type of scattering suppression elements or an alloy thereof.

15. The light amplification element according to claim 14, wherein said scattering suppression element is yttrium, neodymium, tungsten, palladium, bismuth, antimony, molybdenum or an alloy thereof.

16. The light amplification element according to claim 1, wherein said Raman active section is a thin film including single crystal silicon, amorphous silicon, graphite, amorphous carbon, diamond, diamond-shaped carbon, fullerene, carbon nanotube, germanium, silica glass, aluminum oxide, titanium oxide, beryllium oxide, magnesium oxide, indium tin oxide, calcium fluoride, sodium fluoride, lead fluoride, barium fluoride, magnesium fluoride, lanthanum fluoride, lithium fluoride, calcium carbonate, silicon carbide, potassium tantalate, calcium tungstate, arsenic trisulfide glass, magnesium germanide, germanium-selenium-tellurium glass, magnesium siliconide, selenium, zinc selenide, cadmium selenide, arsenic selenide, spinel, thallium bromide, cesium bromide, potassium bromide, thallium bromide/iodide, potassium iodide, cerium iodide, zinc sulfide, cadmium sulfide, indium phosphide or gallium arsenic.

17. The light amplification element according to claim 1, wherein said Raman active section is a thin film containing a transparent ferroelectric substance.

18. The light amplification element according to claim 17, wherein said transparent ferroelectric substance is a thin film containing lithium niobate, lithium tantalate, lead titanate, lead titanate zirconate, lead lanthanum titanate zirconate, strontium titanate or barium titanate.

19. The light amplification element according to claim 1, wherein said Raman active section is an organic compound thin film having lone electron pairs.

20. The light amplification element according to claim 19, wherein said organic compound thin film having a lone electron-pair has a functional group containing nitrogen, oxygen or sulfur.

21. The light amplification element according to claim 1, wherein said Raman active section is an organic compound thin film having n electrons.

22. A light amplification element comprising a metal part having a negative dielectric constant and light amplification element having a Raman active section, wherein signal light is amplified by irradiating excitation light onto said metal part.

23. The light amplification element according to claim 22, wherein stimulated Raman scattering at said Raman active section is enhanced and signal light is amplified through surface plasmon generated by irradiating said excitation light onto said metal part.

24. The light amplification element according to claim 22, wherein when said excitation light is irradiated onto said metal part, at least part of light component of said excitation light is introduced at the position of incidence upon said metal part at an angle at which surface plasmon is generated in said metal part.

25. The light amplification element according to claim 22, wherein said metal part is smooth and the angle of incidence of said excitation light upon said metal part which is an angle formed by said excitation light and the normal to said metal part is an angle at which surface plasmon is generated in said metal part.

26. The light amplification element according to claim 22, wherein said metal part and said Raman active section are arranged adjacent to each other and said excitation light and said signal light are reflected in the interface between said metal part and said Raman active section.

27. The light amplification element according to claim 22, wherein signal light is introduced into one side of said metal part through said Raman active section and excitation light is irradiated onto said metal part from the side opposite to the signal light to amplify the signal light.

28. The light amplification element according to claim 22, wherein said metal part has a rough surface and the convexo-concave structure forming said rough surface is arranged in the traveling direction of said excitation light or said signal light with periodicity.

29. The light amplification element according to claim 22, wherein said metal part has a rough surface and said rough surface has a ridge or groove structure formed perpendicular to the traveling direction of said excitation light or said signal light and periodically.

30. A light amplification apparatus comprising the light amplification element according to claim 1 and a light guide having at least one light leakage region, wherein at least one of said light leakage regions is provided with said light amplification element.

31. The light amplification apparatus according to claim 30, wherein a light leakage region provided with said light amplification element is provided on an end face or side of the light guide.

32. The light amplification apparatus according to claim 30, wherein said light guide is an optical fiber or flat light guide.

33. The light amplification apparatus according to claim 30, wherein the interface between said light leakage region and said Raman active section has a rough surface.

34. The light amplification apparatus according to claim 30, wherein said light guide section has a smooth metal film and said metal part has a rough surface.

35. A light amplification apparatus comprising the light amplification element according to claim 22 and a light guide having at least one light leakage region, wherein at least one of said light leakage regions is provided with said light amplification element.

36. The light amplification apparatus according to claim 35, wherein the light leakage region provided with said light amplification element is provided on an end face or side of the light guide.

37. The light amplification apparatus according to claim 35, wherein said light guide is an optical fiber or flat light guide.

38. The light amplification apparatus according to claim 35, wherein the interface between said light leakage region and said Raman active section has a rough surface.

39. The light amplification apparatus according to claim 35, wherein said light guide section has a smooth metal film and said metal part has a rough surface.

40. A light amplification apparatus comprising the light amplification element according to claim 1 and refraction means.

41. A light amplification apparatus comprising the light amplification element according to claim 22 and refraction means, wherein said excitation light is irradiated onto said metal part at an angle of incidence of plasmon absorption through said refraction means.

42. A light amplification apparatus, said refraction means of which is a prism or axicon lens.

43. A light amplification system comprising the light amplification element according to claim 1 and an excitation light source.

44. A light amplification system comprising the light amplification element according to claim 22 and an excitation light source.

45. A light amplification system comprising the light amplification apparatus according to claim 30 and an excitation light source.

46. A light amplification system comprising the light amplification apparatus according to claim 35 and an excitation light source.

47. A light amplification system comprising the light amplification apparatus according to claim 36 and an excitation light source.
